(19) United States
(12) Patent Application Publication
(10) Pub. No.: US 2005/0140623 A1
(43) Pub. Date: Jun. 30, 2005

(54) Method for driving liquid crystal display device

(76) Inventor: Jang Jin Yoo, Seoul (KR)

Correspondence Address: MCKENNA LONG & ALDRIDGE LLP, 1900 K STREET, NW, WASHINGTON, DC, 20006, US

(21) Appl. No.: 11/017,052

(22) Filed: Dec. 21, 2004

(30) Foreign Application Priority Data
Dec. 24, 2003 (KR) 2003-96877

(51) Int. Cl. G09G 3/36

(52) U.S. Cl. 345/88

(57) ABSTRACT

A method for driving a liquid crystal display device includes controlling a scan signal and sequentially supplying a scan signal to gate lines for ⅓^{rd} of a frame; changing a response speed of liquid crystal molecules according to the scan signal; selectively flashing one of red (R), green (G) and blue (B) backlights; and displaying an image by the red light, green light or blue light transmitting through the arranged liquid crystal molecules, so that transmittance of red light, green light and blue light is improved by improving an arrangement speed of the liquid crystal molecules, and accordingly, uneven brightness of the liquid crystal display device is prevented.

This application claims the benefit of Korean Patent Application No. 2003-96877, filed on Dec. 24, 2003, which is hereby incorporated by reference for all purposes as if fully set forth herein.

### BACKGROUND OF THE INVENTION

1. Field of the Invention

The present invention relates to a method for driving a liquid crystal display device, and more particularly, to a method for driving a liquid crystal display device capable of improving image quality of a liquid crystal display panel using a field-sequential color method.

2. Description of the Background Art

In general, a liquid crystal display (LCD) device includes a liquid crystal display panel formed by attaching a thin film transistor array substrate and a color filter substrate facing each other with a uniform gap therebetween and filling the gap with a liquid crystal material; a driving unit for driving the liquid crystal display panel; and a backlight for supplying light.

A plurality of gate lines arranged horizontally at regular intervals and a plurality of data lines arranged vertically at regular intervals cross each other on the thin film transistor array substrate, and pixels are defined at regions formed by the crossing of the gate lines and the data lines. In each pixel, a switching device and a pixel electrode are provided.

Red, green and blue color filters corresponding to the pixels are formed on the color filter substrate, and a black matrix for preventing light interference is formed along an outer edge of the color filters in a net shape. A common electrode for applying an electric field to a liquid crystal layer together with the pixel electrode formed on the thin film transistor array substrate is provided on a lower surface of the color filter substrate.

The driving unit includes a gate driving unit and a data driving unit. When the gate driving unit sequentially supplies a scan signal to the gate lines for each frame, a switching device of a corresponding gate line receiving the scan signal is turned on. The data driving unit provides image information to the switching device through the data lines, and the switching device provides the image information to the pixel electrode of the pixel.

The pixel electrode controls the arrangement of liquid crystal molecules by an electric field formed by a voltage difference with the common electrode, thereby controlling light transmitted through the liquid crystal layer. In such a manner, the image information is displayed on the LCD panel.

However, the related art LCD device as described above has the following problems.

First, because the maximum transmittance of light transmitted through the color filter is about 33%, great light loss results. Accordingly, if light generated from a backlight becomes brighter in order to improve brightness of the LCD device, the power consumption of the device is increased.

Also, the color filter is expensive in comparison with other materials, which results in an increase in production cost of the LCD device.

In order to solve the above-mentioned problems, an LCD device using a field-sequential color method that can implement full-color without a color filter has been proposed.

In general, when the LCD device is driven, a backlight of the LCD device supplies white light, thereby displaying an image on a LCD panel by a mixture of light transmitting through the color filter. However, the LCD device using the field-sequential color method displays a color image by turning on a backlight emits red, green and blue light at regular time intervals for one frame.

FIG. 1 is a schematic view illustrating an LCD device using a field-sequential color method.

Referring to FIG. 1, the LCD device using a general field-sequential color method includes a first substrate 70 and a second substrate 90 attached facing each other with a uniform gap therebetween, a liquid crystal layer 80 formed at the gap between the first substrate 70 and the second substrate 90; a backlight 100 located at a rear surface of the second substrate 90 supplying red, green and blue light to an LCD panel 65 including the first substrate 70, the second substrate 90 and the liquid crystal layer 80.

In order to divide pixels through which light transmits, a black matrix 72 for blocking light is formed on a lower surface of a transparent substrate 71 along outer edges of the pixels in a net shape.

A common electrode 73 is provided on the lower surface of the transparent substrate 71 on which the black matrix 72 has been formed.

A thin film transistor (TFT) functioning as a switch and a transparent pixel electrode 92 applying an electric field to the liquid crystal layer 80 together with the transparent common electrode 73 upon receiving a signal from the thin film transistor (TFT) are provided on a transparent substrate 91 of the second substrate 90.

Although not shown in the drawing, a plurality of gate lines arranged horizontally at regular intervals and a plurality of data lines arranged vertically at regular intervals cross each other on the transparent substrate of the second substrate 90, and pixels are defined at regions formed by the crossing of the gate lines and the data lines. The pixels are arranged in a matrix configuration on the first substrate 70. The pixels individually include pixel electrodes 92.

In addition, the thin film transistor (TFT) includes a gate electrode electrically connected to the gate lines, a source electrode electrically connected to the data lines; and a drain electrode electrically connected to the pixel electrode 92.

Unlike the general LCD device, the LCD device using the field-sequential color method does not require a color filter because red, green and blue backlights 100 individually flash.

The flash of each of red, green and blue lights occurs 60 times per second for each ⅓ frame on for a 60 Hz device. Although the red, green and blue backlights flicker 180 times per second, a human perceives that the red, green and blue backlights are lit simultaneously. Through this afterimage effect of human eyesight, red, green and blue are mixed to display a variety of colors.

FIG. 2 schematically illustrates an exemplary structure of a thin film transistor array substrate in order to explain driving of the LCD device using a field-sequential color method.

Referring to FIG. 2, a plurality of gate lines 101 horizontally arranged at regular intervals and a plurality of data lines 102 vertically arranged at a regular intervals cross each other, and pixels are defined in quadrangular regions made by the crossing of the gate lines 101 and the data lines 120.

A thin film transistor (TFT) is provided at a crossing of the gate line 101 and the data line 102, and a pixel electrode 103 electrically connected to the thin film transistor (TFT) is provided in a unit pixel region except the thin film transistor (TFT).

In order to display an image, the LCD device is driven so that a scan signal is supplied to the pixel through the gate lines 101 and image information is provided to a corresponding gate line 101 through the data line 102. In the LCD device, a scan signal is sequentially applied to the gate lines 101 for every horizontal period to turn on the thin film transistors (TFT) connected to the corresponding gate line 101. At this time, the image information is provided to the pixel through the turned-on thin film transistors (TFT) through the data line 120. In this manner, a scan signal is applied to every gate line 101. If the image information is supplied to every pixel, an image for one frame is completed.

More particularly, when a scan signal is supplied to a K^{th} gate line 101, every thin film transistor (TFT) electrically connected to the K^{th} gate line 101 is simultaneously turned on, and the image information on the data lines 102 is provided to the pixel electrodes 103 through the turned-on thin film transistors (TFT).

The pixel electrode 103 receiving the image information applies an electrical field to the liquid crystal layer together with the common electrode, which is formed on the color filter substrate and receives a common voltage. The image information is provided to the pixel electrode 103 and charged in a capacitor (not shown) provided in each pixel and electrically connected to the pixel electrode 103.

When an electric field is applied to the liquid crystal layer, the direction in which the liquid crystal molecules in the liquid crystal layer are arranged is changed. The red, green and blue backlights flash sequentially, and a color image is implemented by a mixture of red, green and blue lights selectively transmitting through the liquid crystal layer according to the arranged direction of the liquid crystal molecules.

FIG. 3 is a graph illustrating light transmittance of a backlight according to a change in arrangement of liquid crystal molecules.

In FIG. 3, a case in which a scan signal is supplied to one gate line is illustrated.

When a scan signal is supplied to gate lines from the gate driving unit, an electric field is formed at the liquid crystal layer by a voltage difference between the common electrode and the pixel electrode, and the direction in which the liquid crystal molecules are arranged is changed according to the applied electric field. The liquid crystal molecules respond to the electric field for a certain length of time. As illustrated, the liquid crystal molecules slowly respond to the electric field, changing their arrangement direction. Because of their viscosity, an elastic restitution force or the like, the liquid crystal molecules slowly respond to the electric field and cannot directly reach desired light transmittance.

One frame of the LCD device is divided into three, and each ⅓^{rd} of a frame is allocated as each flashing time of the red (R), green (G) and blue backlights. Each ⅓^{rd} of the frame is divided into the time for which a scan signal is applied (to a gate line), the time for which liquid crystal molecules respond to an electric field and the time for which the backlight flashes.

As shown, during the first ⅓^{rd} of the frame, the liquid crystal molecules slowly respond to the electric field as a scan signal is sequentially applied to each gate line to provide the image information to each pixel, and the red (R) backlight flashes after a certain time elapses, so that red light transmits through the liquid crystal layer. However, its transmittance is less than 100%. In addition, an electric charge accumulates in the liquid crystal layer as much as a difference between a voltage of the image information supplied to the pixel electrode and a common voltage while the scan signal is applied to the gate line. A relatively large amount of electric charge is maintained therein until the next electric field is applied to the liquid crystal layer, thereby keeping up the response of the liquid crystal molecules.

If a scan signal is applied again to each gate line in next ⅓^{rd} of the frame, the liquid crystal molecules start to respond to an electric field in their arrangement states when the red (R) backlight flashes. At this time, the light transmittance reaches 100% before the green (G) backlight flashes, and thus green light of the green (G) backlight transmits through the liquid crystal layer with its transmittance of 100%. In general, if the green light and the red light were mixed at an exact ratio of one to one, an image would be displayed in yellow. However, uneven brightness may occur between the red light which is not completely transmitted and the green light which is completely transmitted, and thus an image is displayed on the LCD device is yellow tinted green.

In addition, such a slow response time of liquid crystal molecules results in uneven brightness between an upper region and a lower region of the LCD panel, which are different in time when a scan signal is applied thereto.

FIG. 4 is a graph illustrating a relation between a response of liquid crystal molecules and light transmittance according to a gate line.

Referring to FIG. 4, a case in which a scan signal is applied to an N^{th} gate line is compared to a case in which the signal is applied to an Mₜₕ gate line.

First, when a scan signal is supplied to the Nth gate line in first ⅓^{rd} of a frame, liquid crystal molecules start to respond to an electric field. After a certain time elapses, a red (R) backlight flashes, so that red light transmits through a liquid crystal layer. Then, when a scan signal is applied to the N^{th} gate line in next ⅓^{rd} of the frame, the liquid crystal molecules cumulatively start to respond to an electric field in their arrangement state in the first ⅓^{rd} of the frame. After a certain time elapses, a green (G) light flashes, so that green light transmits through the liquid crystal layer. Likewise, in next ⅓^{rd} of the frame, the liquid crystal molecules respond to an electric field by a scan signal, so that blue light transmits through the liquid crystal layer. Unlike the red light and the green light, the blue light is completely transmitted with light transmittance of 100%.

Furthermore, when a scan signal is supplied to an M^{th} gate line in first ⅓^{rd} of the frame, the liquid crystal molecules start to respond to an electric field when the scan signal is applied thereto. After a small time in comparison with the N^{th} gate line elapses, a red (R) backlight flashes. At this time, because the liquid crystal molecules do not have an enough time to be sufficiently arranged, the transmittance of the red light is low. Then, when a scan signal is applied again to the M^{th} gate line in next ⅓^{rd} of the frame, the liquid crystal molecules are rearranged in their arrangement state in the first ⅓^{rd} of the frame. At this time, the image information is provided to a pixel and thus a new electric charge is charged in the liquid crystal layer while the scan signal is applied to the gate line, thereby slightly increasing a response speed of the liquid crystal molecules. When a certain time elapses after the arrangement of the liquid crystal molecules is started, the green (G) backlight flashes, so that the green light transmits through the liquid crystal layer. Here, the transmittance of the green light is higher than that of the red light.

Likewise, in next ⅓^{rd} of the frame, a scan signal is supplied again to the M^{th} gate line, and the blue light transmits through the liquid crystal layer.

The N^{th} gate line and the M^{th} gate line are different in the point in time at which the scan signal is applied thereto even-in the same ⅓^{rd} of a frame. Such a difference in the time point when the scan signal is supplied thereto makes the point in time when the arrangement of the liquid crystal molecules is started different, thereby resulting in a difference in light transmittance among the red, green and blue lights when the red (R), green (G) and blue (B) backlights flash. Namely, a gate line located at a lower region of an image receives a scan signal late in ⅓^{rd} of a frame in comparison with an upper region of the screen. In this case, a time point when the liquid crystal molecules start to respond to an electric field becomes late. For this reason, light of the backlight transmits through a liquid crystal layer in a state that the liquid crystal response time is not sufficient. Accordingly, when comparing colors of the same backlight of an image, the light transmittance gets lower from the upper region toward the lower region on the screen. Thus, in an entire image, brightness becomes high in its upper region and becomes low in its lower region. Namely, uneven brightness results.

### SUMMARY OF THE INVENTION

Accordingly, the present invention is directed to a liquid crystal display device that substantially obviates one or more of the problems due to limitations and disadvantages of the related art.

Therefore, an advantage of the present invention is to provide a method for driving an LCD device, which improves image quality of the LCD device by improving light transmittance of a backlight by accelerating a response time of liquid crystal molecules to an electric field upon controlling the number of times that a scan signal is applied to a gate line or the time for which a scan signal is applied to a gate line.

To achieve these and other advantages and in accordance with the purpose of the present invention, as embodied and broadly described herein, there is provided a method for driving a liquid crystal display device using a field-sequential color method and including a liquid crystal display panel formed by attaching a first substrate on which a plurality gate lines and a plurality of data lines are vertically and horizontally arranged and a second substrate; and a backlight for selectively supplying red light, green light and blue light to the liquid crystal display panel, comprising: controlling a scan signal and sequentially applying a scan signal to gate lines for ⅓^{rd} of a frame; changing a response speed of liquid crystal molecules according to the scan signal; selectively flashing one of red (R), green (G) and blue (B) backlights; and displaying an image by the red light, green light or blue light transmitting through the arranged liquid crystal molecules.

The foregoing and other advantages of the present invention will become more apparent from the following detailed description of the present invention when taken in conjunction with the accompanying drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view illustrating an LCD device using a field-sequential color method;

FIG. 2 is an exemplary view schematically illustrating a structure of a thin film transistor array substrate in order to explain the driving of the LCD device using the field sequential color method;

FIG. 3 is a graph illustrating light transmittance of a backlight according to a change in arrangement of liquid crystal molecules;

FIG. 4 is a graph illustrating a relation between a response of the liquid crystal molecules and light transmittance according to gate lines;

FIG. 5 is a graph illustrating a relation between a response state of the liquid crystal molecules according to supplying a scan signal a plurality of times; and

FIG. 6 is a graph comparing relations between a response of liquid crystal molecules and light transmittance of a plurality of gate lines according to applying a scan signal a plurality of times.

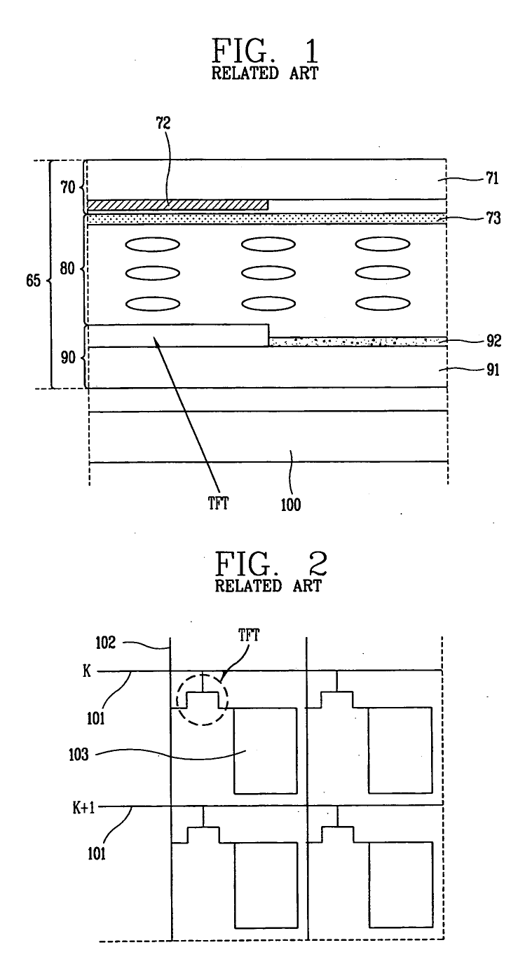

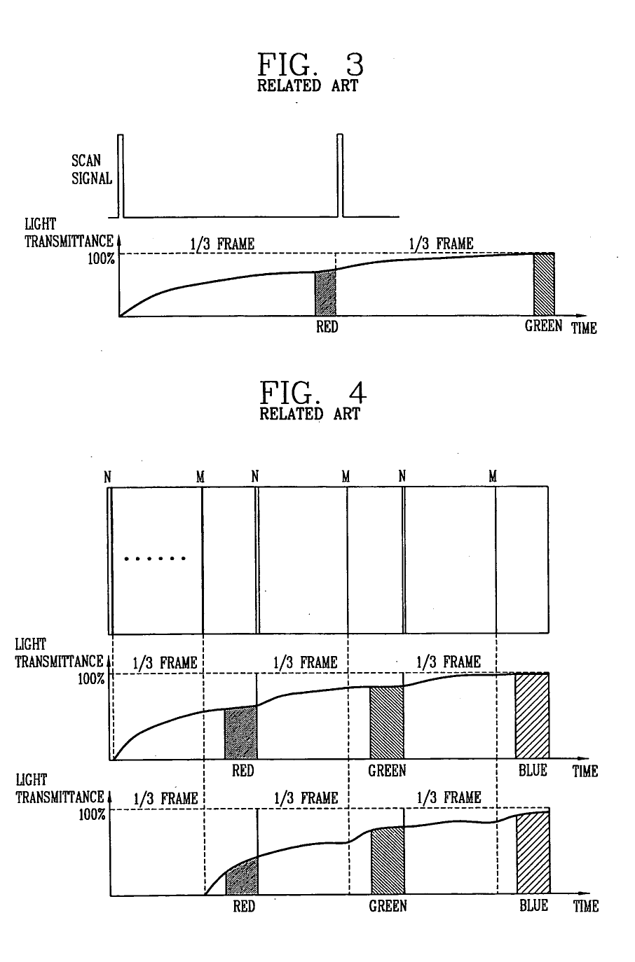

### DETAILED DESCRIPTION OF THE ILLUSTRATED EMBODIMENTS

Reference will now be made in detail to embodiments of the present invention, examples of which are illustrated in the accompanying drawings.

The present invention can be characterized in that an arrangement of liquid crystal molecules achieves sufficient light transmittance before the backlight flash occurs by supplying a sufficient amount of electric charge to the liquid crystal layer by increasing the number of times that a scan signal is supplied to a gate line or increasing the time for which the scan signal is supplied to a gate line in order to solve uneven brightness caused by the fact that red light, green light and blue light transmit through a liquid crystal layer with different transmittance because the liquid crystal molecules are not in a desired arrangement due to their slow response speed.

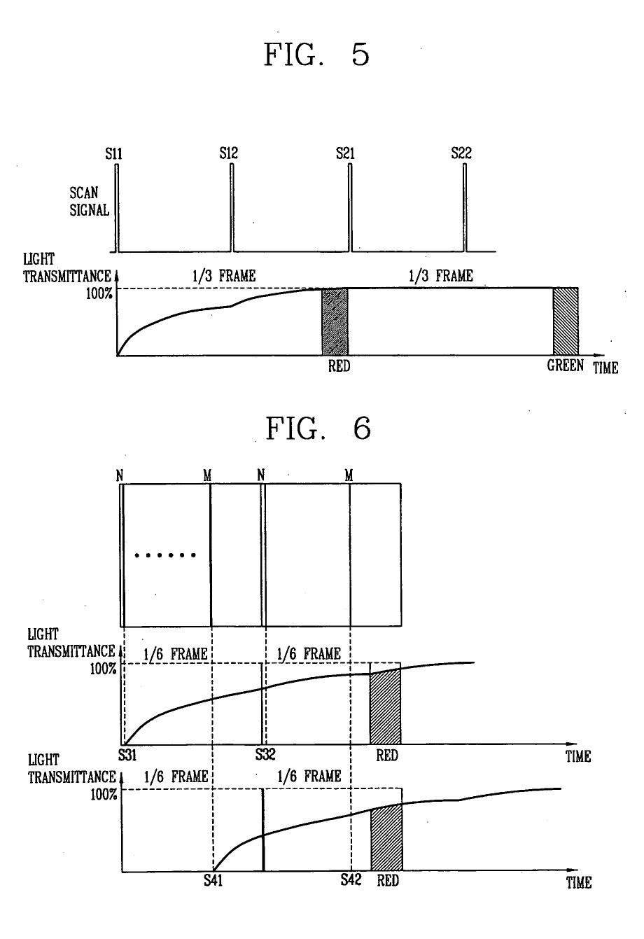

FIG. 5 is a graph illustrating a relation between a response state of liquid crystal molecules and light transmittance according to supplying a scan signal to a gate line a plurality of times, in accordance with the present invention.

Although not illustrated in the drawing, a first substrate and a second substrate are attached together at a certain interval in a facing manner, and a liquid crystal layer is provided between a uniform gap between the two substrates, thereby forming a liquid crystal display (LCD) panel. A plurality of data lines vertically arranged at regular intervals and a plurality of gate lines horizontally arranged at regular intervals are formed on the first substrate.

A pixel electrode is provided on the first substrate, a common electrode is provided on the second substrate, and an electric field is applied to a liquid crystal by a voltage difference between voltages applied to the pixel electrode and the common electrode. Here, the amount of charged electric charge in the liquid crystal layer is varied in proportion to an applied electric field, and a response speed of liquid crystal molecules is varied according to the amount of electric charge. Referring to FIG. 5, the number of times that a scan signal is supplied to a same gate line for ⅓^{rd} of a frame is increased to twice.

Namely, when a first scan signal (S11) is supplied to gate lines during first ⅓^{rd} of a frame, a voltage relating to image information is applied to a pixel so that an electric field is formed at a liquid crystal layer. Accordingly, the liquid crystal molecules start arrangement changes in response to the electric field, and, even after the first scan signal (S11) drops to a low potential, the response of the liquid crystal molecules is continued by electric charge charged in the liquid crystal layer. When a second scan signal (S12) is supplied to the same gate line, a voltage of image information is applied to the pixel again. Thus, an electric charge is again charged in the liquid crystal layer, thereby accelerating a response of the liquid crystal molecules and increasing a speed at which the arrangement of the liquid crystal molecules is changed. Accordingly, the liquid crystal molecules reach their desired arrangement state before a red (R) light flashes, so that red light completely transmits through the liquid crystal layer when the red (R) backlight flashes. Namely, the desired brightness can be exactly achieved.

When a first scan signal (S21) is supplied to the gate line in next ⅓^{rd} of the frame, the arrangement of the liquid crystal molecules is started in the arrangement state completed in the previous ⅓^{rd} of the frame. Even though being returning to their initial arrangement state because their arrangement has already been completed in the previous ⅓^{rd} of the frame, the liquid crystal molecules can be easily rearranged to be in a desired state before a green (G) backlight flashes because the extent of their return is very small.

By supplying a scan signal to the same gate line at least twice for each ⅓^{rd} of a frame in which the red (R), green (G) and blue (B) backlight flash, a speed at which the liquid crystal molecules are arranged in response to an electric field is increased and thus the liquid crystal molecules can reach their desired arrangement state more rapidly, before a corresponding backlight flashes. Accordingly, the desired light transmittance can be obtained from the red (R) light which is the first to flash, so that the desired brightness and colors can be implemented and thus uneven brightness of an image can be prevented. Here, a flashing order of the red (G), green (G) and blue (B) backlights in one frame may be selectively set.

In an alternative to the method of increasing the number of times that a scan signal is supplied for every ⅓ frame, the same effect can be obtained by controlling the time for which the scan signal is supplied to gate lines. In this method, the time for which a voltage of image information is applied to a pixel is increased by lengthening the time for which a scan signal is supplied to the gate lines, thereby a sufficient amount of electric charges are charged in the liquid crystal layer. Because a response speed of the liquid crystal molecules having a sufficient amount of electric charge is improved, the time taken for the liquid crystal molecules to reach a desired arrangement is shortened.

FIG. 6 is a graph comparing the relationship between the response of the liquid crystal molecules and light transmittance based on supplying a scan signal to a plurality of gate lines a plurality of times, in accordance with the present invention.

Referring to FIG. 6, when a first scan signal (S31) is supplied to an N^{th} gate line, rearrangement of liquid crystal molecules of a pixel corresponding to the N^{th} gate line is started by an electric field formed between the common electrode and the pixel electrode. The liquid crystal molecules respond to the electric field at a certain speed based on their physical characteristics. When a second scan signal (S32) is supplied to the N^{th} gate line when ⅙^{th} of a frame elapses, an arrangement speed of the liquid crystal molecules is increased so that the liquid crystal molecules are almost in a desired arrangement state.

Meanwhile, when a first scan signal (S41) is supplied to an M^{th} gate line, liquid crystal molecules of a pixel corresponding to the M^{th} gate line respond to an electric field so that a change in the liquid crystal molecules arrangement is started. The M^{th} gate line is a gate line located at a lower region of a screen. Although a response time of liquid crystal molecules during a period when the first scan signal is supplied to the gate line to when the backlight flashes is not sufficient, the amount of electric charge is increased in the liquid crystal layer of the corresponding pixel by supplying a second scan signal (S42), thereby accelerating the response speed of the liquid crystal molecules. Accordingly, the liquid crystal molecules can reach their desired arrangement state sooner. In the drawing, which illustrates but one exemplary embodiment, the light transmittance does not reach 100%, but by increasing the number of times that a scan signal is supplied, the light transmittance can be sufficiently controlled to be 100%.

As described above, the red light, the green light and the blue light can transmit through a liquid crystal layer with desired transmittance by accelerating the response time of the liquid crystal molecules by supplying a scan signal to the same gate line twice or more. Accordingly, a brightness difference due to a time difference between when a scan signal is supplied to an upper region of the screen and when a scan signal is supplied to a lower region of the screen can be prevented. In addition, when supplied to a same gate line a plurality of times, the scan signal may be supplied at regular intervals, or may be supplied at different, irregular intervals. For example, supplying a scan signal to a gate line intensively in the front of ⅓^{rd} of a frame can shorten the molecular arrangement completion time of the liquid crystal in comparison to supplying a scan signal to a gate line at regular intervals for ⅓^{rd} of a frame.

As described thus far, in the method for driving a liquid crystal display device in accordance with the present invention, a response speed of liquid crystal molecules is increased by controlling the number of times that a scan signal is supplied to a gate line and the length of time during which a scan signal is supplied to the gate line, so that the liquid crystal molecules reach their desired arrangement state. Accordingly, the red light, the green light and the blue light transmit through the liquid crystal layer with desired transmittance, thereby preventing uneven brightness among red, green and blue from occurring and thus preventing image deterioration of an LCD device.

In addition, uneven brightness due to the time difference between when a scan signal is supplied to an upper region of the screen and when a scan signal is supplied to a lower region of the screen can be prevented by achieving desired transmittance in an early stage.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for driving a liquid crystal display device using a field-sequential color method and including a liquid crystal display panel formed by attaching a first substrate on which a plurality gate lines and a plurality of data lines are vertically and horizontally arranged to a second substrate; and backlights for selectively supplying red light, green light and blue light to the liquid crystal display panel, comprising:
controlling a scan signal and sequentially supplying the scan signal to gate lines for ⅓^{rd} of a frame;
changing a response speed of liquid crystal molecules according to the scan signal;
selectively flashing one of red (R), green (G) and blue (B) backlights; and
displaying an image by the red light, green light or blue light transmitting through the arranged liquid crystal molecules.

2. The method of claim 1, wherein the scan signal is supplied to the same gate line at least twice for ⅓^{rd} of a frame.

3. The method of claim 2, wherein the scan signal is supplied to the same gate line at regular intervals.

4. The method of claim 2, wherein the scan signal is supplied to the same gate line at different intervals.

5. The method of claim 1, wherein the time for which a scan signal is supplied to the gate line is increased.

6. The method of claim 1, wherein transmittance of light through the liquid crystal layer is raised to 100% by supplying the scan signal before the backlight flashes in each ⅓ frame.
